(19) United States
(12) Patent Application Publication
(10) Pub. No.: US 2007/0216288 A1
(43) Pub. Date: Sep. 20, 2007

(54) An Emission Layer of an Organic Light-Emitting Diode and an Organic Light Emitting Material Thereof

(75) Inventors: Cheng-Hung Lin, Hemei Township (TW); Chung-Wen Ko, Sijhih City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORPORATION, Hsin-Chu (TW)

(21) Appl. No.: 11/462,116

(22) Filed: Aug. 3, 2006

(30) Foreign Application Priority Data
Mar. 15, 2006 (TW) 95108857

(51) Int. Cl. C09K 11/06; H01J 1/62

(52) U.S. Cl. 313/504; 313/506; 313/486; 252/301.16

(57) ABSTRACT

An emission layer of an organic light-emitting diode has a host and a dopant. The dopant is doped in the host, and the dopant has the structure shown in formulas I, II, III, IV, V or VI,

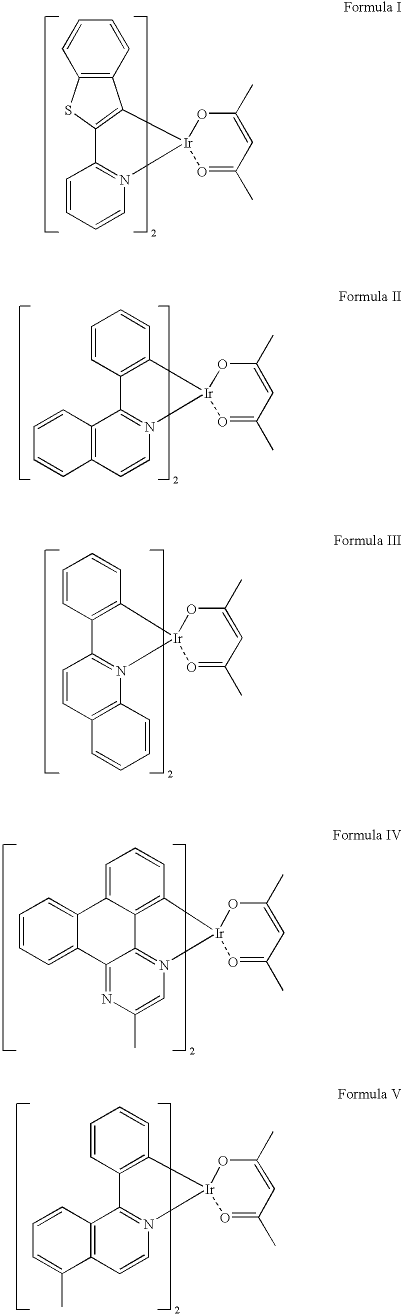

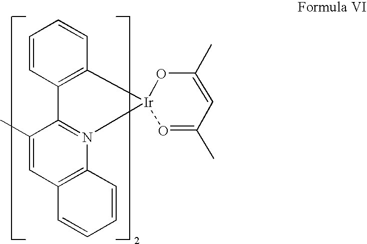

### RELATED APPLICATIONS

The present application is based on, and claims priority from, Taiwan Patent Application Serial Number 95108857, filed Mar. 15, 2006, the disclosure of which is hereby incorporated by reference herein in its entirety.

### BACKGROUND

1. Field of Invention

The present invention relates to organic light-emitting diode displays. More particularly, the present invention relates to an emission layer of an organic light-emitting diode and an organic light emitting material thereof.

2. Description of Related Art

Organic light-emitting diode (OLED) displays have gained a significant market share in recent years due to their advantages of self-emission, high brightness, wide viewing angle, high reaction speeds, low driving voltage and light weights. However, the market share of the OLED displays is still limited. Therefore, OLED display manufacturers use a great deal of effort to develop optimum OLED displays manufacturing method to improve the manufacturing yield rate and popularize the use of OLED displays as well.

OLED displays are a kind of self-emissive flat panel display. Light emission of the OLED display is based on transforming electric power into light energy using organic light-emitting diodes. Therefore, the maximum brightness of the OLED display is determined by adjusting the amount of electric current passing through the organic light-emitting diodes. The gray-level brightness of the OLED displays is determined by thin film transistors electrically coupled with the organic light-emitting diodes.

Traditionally, the OLED display is colorized by employing metal masks to define the position of primary colors, such as red, green and blue. Another method to colorize the OLED display is to employ white organic light-emitting diodes (WOLEDs) to emit white light. The white light is then filtered by a color filter to provide required colors.

Generally, the white light emitted by the WOLED has many color light components, and each color light component has a different wavelength. When the white light passes through the color filter, some color light components with specific wavelengths are absorbed by photo-resists coated on the color filter, and other colored light components with different wavelengths, penetrate the photo-resists and have a single color. However, commercial green photo-resists have a large penetration range, that is, not only green light components have the ability to penetrate the green photo-resists, but orange light components with wavelengths of about 600 nm can also penetrate the green photo-resists. Moreover, the white light emitted by a typical WOLED usually has a red light component, and its intensity peak is generally located within a wavelength range from about 580 nm to about 600 nm. Thus, almost half of the red light component penetrates the green photo-resists coated on the color filter. Therefore, the display efficiency and the saturation of the OLED displays are still not good enough.

### SUMMARY

It is therefore an aspect of the present invention to provide an organic light emitting material. The organic light emitting material can be applied to a WOLED. The WOLED has organic light emitting material therein that can emit white light with an appropriate emission spectrum. Thus, when the white light passes through green photo-resists coated on a color filter, the remaining color light component is saturated green.

According to one preferred embodiment of the present invention, an organic light emitting material is provided. The organic light emitting material emits an emission spectrum with a light intensity ratio of a first wavelength range to an absolute peak of the emission spectrum. The light intensity ratio is equal to or less than 0.2:1, and the first wavelength range is equal to or less than 588 nm. Generally, commercial green photo-resists have a wavelength penetration range from about 480 nm to about 600 nm. Therefore, as long as the light intensity over the first wavelength is much smaller than the light intensity at the absolute peak, the amount of orange light components that penetrate the green photo-resists, is less than the prior art.

More specifically, the emission spectrum has a wavelength light emitting range from about 560 nm to about 750 nm. That is, the organic light emitting material according to this preferred embodiment is a red organic light emitting material. When the red organic light emitting material is combined with a blue organic light emitting material and a green organic light emitting material to become a WOLED, the WOLED emits white light with an appropriate emission spectrum. Thus, when the white light passes through the green photo-resists, the remaining color light component is saturated green.

Moreover, the absolute peak of the emission spectrum is located within a second wavelength range from about 620 nm to about 750 nm. When a WOLED employing the organic light emitting material according to the preferred embodiment emits white light, the intensity peak at the red light component of the white light is shifted from the wavelength range from about 580 nm to about 600 nm. Therefore, the amount of orange light components that penetrate the green photo-resists is less than the prior art.

It is another aspect of the present invention to provide an organic light emitting material. When a WOLED employing the organic light emitting material emits white light, the intensity peak at the red light component of the white light is shifted from the wavelength range from about 580 nm to about 600 nm. Therefore the amount of orange light components that penetrates the green photo-resists, is less than the prior art.

According to another preferred embodiment of the present invention, an organic light emitting material in provided. The organic light emitting material emits an emission spectrum with an absolute peak located within a first wavelength range from about 620 nm to about 750 nm. When a WOLED employing the organic light emitting material according to the preferred embodiment emits white light, the intensity peak at the red light component of the white light is shifted from the wavelength range from about 580 nm to about 600 nm. Therefore, the orange light components, that penetrate the green photo-resists, is less than the prior art.

Moreover, the emission spectrum further has a light intensity ratio of a second wavelength range to the absolute peak of the emission spectrum. The light intensity ratio is equal to or less than 0.2:1, and the second wavelength range is equal to or less than 588 nm. Generally, commercial green photo-resists have a wavelength penetration range from about 480 nm to about 600 nm. Therefore, as long as the light intensity over the first wavelength is much smaller than the light intensity at the absolute peak, the amount of orange light components that penetrate the green photo-resists, is less than the prior art.

It is yet another aspect of the present invention to provide an emission layer of an organic light-emitting diode which can emit light with an appropriate emission spectrum. Therefore, an OLED display which employs the organic light-emitting diode has the ability to provide a saturated green.

According to yet another preferred embodiment of the present invention, an emission layer of an organic light-emitting diode has a host and a dopant. The dopant is doped in the host, and the dopant has the structure shown in formulas I, II, III, IV, V or VI,

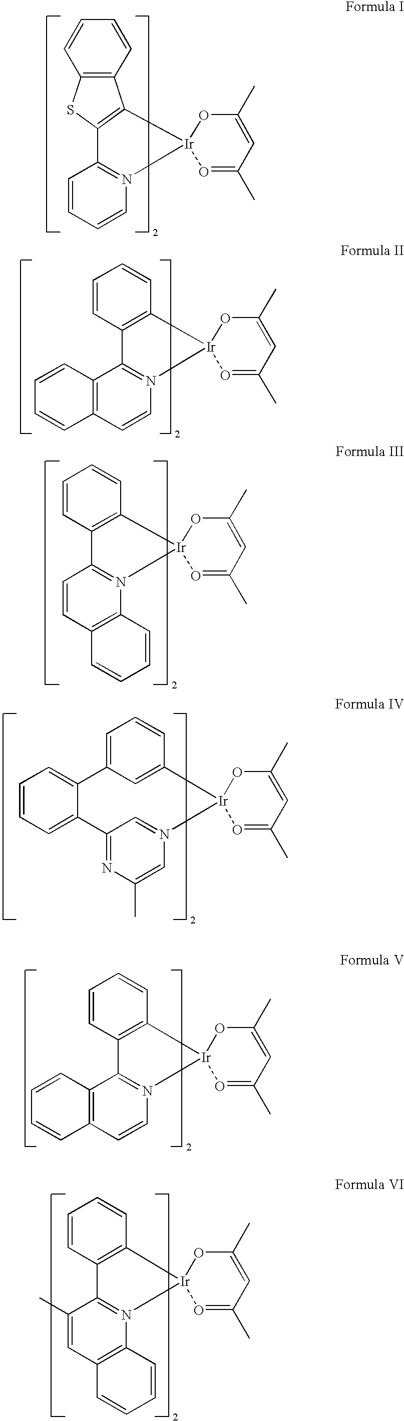

Moreover, the host may be doped with about 6 wt % to about 15 wt % of the dopant. Following the mentioned concentration, the organic light-emitting diode emits light with an appropriate emission spectrum. Therefore, the OLED display that employs the organic light-emitting diode can provide a saturated green.

More specifically, the emission layer emits an emission spectrum with a light intensity ratio of a first wavelength range to an absolute peak of the emission spectrum. The light intensity ratio is equal to or less than 0.2:1, and is the first wavelength range is equal to or less than 588 nm. Generally, commercial green photo-resists have a wavelength penetration range from about 480 nm to about 600 nm. Therefore, as long as the light intensity over the first wavelength is much smaller than the light intensity at the absolute peak, the amount of orange light components with wavelengths of less than 588 nm, which penetrate the green photo-resists, is less than the prior art.

Furthermore, the emission spectrum has a wavelength light emitting range from about 560 nm to about 750 nm. That is, the emission layer according to this preferred embodiment is a red organic light emitting material. When the red organic light emitting material is combined with a blue organic light emitting material and a green organic light emitting material to become a WOLED, the WOLED emits white light with an appropriate emission spectrum. Thus, when the white light passes through the green photo-resists, the remaining color light component is saturated green.

In addition, the absolute peak of the emission spectrum is located within a second wavelength range from about 620 nm to about 750 nm. When a WOLED employs the emission layer according to the preferred embodiment, the intensity peak at the red light component of the white light emitted by the WOLED is shifted from the wavelength range from about 580 nm to about 600 nm. Therefore, the amount of orange light components, which penetrate green photo-resists, is less than the prior art.

In conclusion, the emission layer of the organic light-emitting diode and the organic light emitting material disclosed by the present invention can increase the display efficiency and the saturation of OLED displays effectively.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an emission spectrum of an organic light emitting material according to one preferred embodiment of this invention;

FIG. 2 is a diagram showing an emission layer of an OLED according to one preferred embodiment of this invention;

FIG. 3 is an emission spectrum of a blue organic light emitting material according to one example of this invention;

FIG. 4 is an emission spectrum of a green organic light emitting material according to one example of this invention; and

FIG. 5 is an emission spectrum of a WOLED according to one example of this invention.

### DESCRIPTION OF THE PREFERRED EMBODIMENTS

Reference is now made in detail to the present preferred embodiments of the invention, examples of which are illustrated in the accompanying drawings. Wherever possible, the same reference numbers are used in the drawings and the description to refer to the same or like parts.

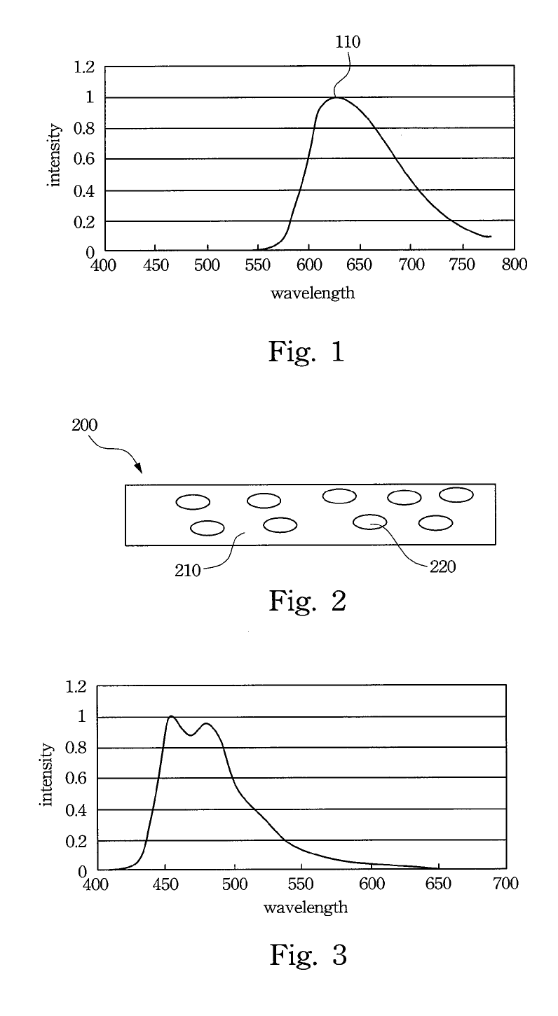

Reference is made to FIG. 1, which is an emission spectrum of an organic light emitting material according to one preferred embodiment of this invention. In this embodiment, an organic light emitting material is provided. The organic light emitting material emits an emission spectrum with a light intensity ratio of a first wavelength range to an absolute peak 110 of the emission spectrum. The light intensity ratio is equal to or less than 0.2:1, and the first wavelength range is equal to or less than 588 nm. Generally, commercial green photo-resists have a wavelength penetration range from about 480 nm to about 600 nm. Therefore, as long as the light intensity over the first wavelength is much smaller than the light intensity at the absolute peak, the amount of orange light components with wavelengths of less than 588 nm, which penetrate the green photo-resists, is less than the prior art.

Continuously referring to FIG. 1, the emission spectrum has a wavelength light emitting range from about 560 nm to about 750 nm. That is, the organic light emitting material according to this preferred embodiment is a red organic light emitting material. When the red organic light emitting material is combined with a blue organic light emitting material and a green organic light emitting material to become a WOLED, the WOLED emits white light with an appropriate emission spectrum. Thus, when the white light passes through the green photo-resists, the remaining color light component is saturated green.

Moreover, the absolute peak 110 of the emission spectrum is located within a second wavelength range from about 620 nm to about 750 nm. When a WOLED employing the organic light emitting material according to the preferred embodiment emits white light, the intensity peak at the red light component of the white light is shifted from the wavelength range from about 580 nm to about 600 nm. Therefore, the amount of the orange light components, which penetrate the green photo-resists, is less than the prior art.

Reference is made to FIG. 2, which is diagram showing an emission layer of an OLED according to one preferred embodiment of this invention. FIG. 2 is not drawn to scale for easy to illustration. In FIG. 2, an emission layer 200 of an organic light-emitting diode has a host 210 and a dopant 220. The dopant 220 is doped in the host 210, and the dopant 220 has the structure shown in formulas I, II, III, IV, V or VI,

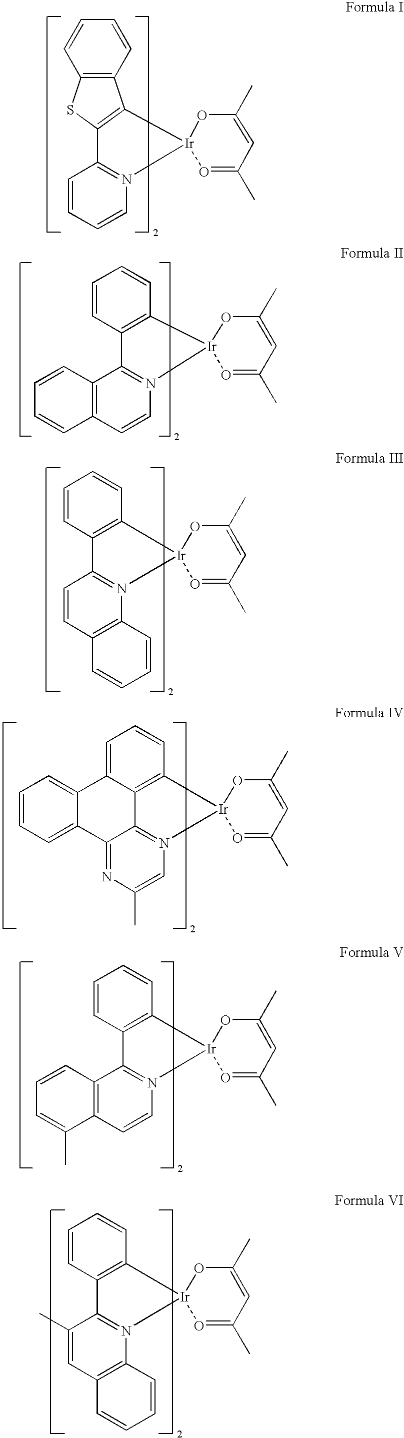

Moreover, the host 210 may be doped with about 6 wt % to about 15 wt % of the dopant 220. Following the mentioned concentration, the organic light-emitting diode emits light with an appropriate emission spectrum. Therefore, the OLED display that employs the organic light-emitting diode has the ability to provide a saturated green.

More specifically, the emission layer emits an emission spectrum with a light intensity ratio of a first wavelength range to an absolute peak of the emission spectrum. The light intensity ratio is equal to or less than 0.2:1, and the first wavelength range is equal to or less than 588 nm. Generally, commercial green photo-resists have a wavelength penetration range from about 480 nm to about 600 nm. Therefore, as long as the light intensity over the first wavelength is much smaller than the light intensity at the absolute peak, the amount of the orange light components with wavelengths of less than 588 nm, which penetrates the green photo-resists, is less than the prior art.

Furthermore, the emission spectrum has a wavelength light emitting range from about 560 nm to about 750 nm. That is, the emission layer according to this preferred embodiment is a red organic light emitting material. When the red organic light emitting material is combined with a blue organic light emitting material and a green organic light emitting material to become a WOLED, the WOLED emits white light with an appropriate emission spectrum. Thus, when the white light passes through the green photo-resists, the remaining color light component is saturated green.

In addition, the absolute peak of the emission spectrum is located within a second wavelength range from about 620 nm to about 750 nm. When a WOLED employs the emission layer according to the preferred embodiment, the intensity peak at the red light component of the white light emitted by the WOLED is shifted from the wavelength range from about 580 nm to about 600 nm. Therefore, the amount of orange light components, which penetrate green photo-resists, is less than prior art.

The followings provide an example to show the display efficiency of an OLED display which the organic light emitting material according to the mentioned embodiments applied to. In the present example, a typical color filter is configured in the OLED display, and green photo-resists coated on the color filter have a wavelength penetration range from about 580 nm to about 620 nm. When white light emitted by a typical WOLED passes through the color filter, the remaining color light components and a white light combination thereof are represented by CIE coordinates as the following table 1 lists.

TABLE 1
The remaining color light components and the white light
combination thereof are represented by CIE coordinates when the white
light emitted by the typical WOLED passes through the color filter.

| | CIEx | CIEy |
|---|---|---|
| White | 0.312 | 0.339 |
| Red | 0.632 | 0.354 |
| Green | 0.290 | 0.513 |
| Blue | 0.136 | 0.124 |

With reference to table 1, when the white light emitted by the typical WOLED passes through the color filter, the remaining green light component has poor CIE coordinates. This is because the wavelength penetration range of the green-resists is too large. Therefore, orange light components with wavelengths of about 600 nm penetrate the green-resists.

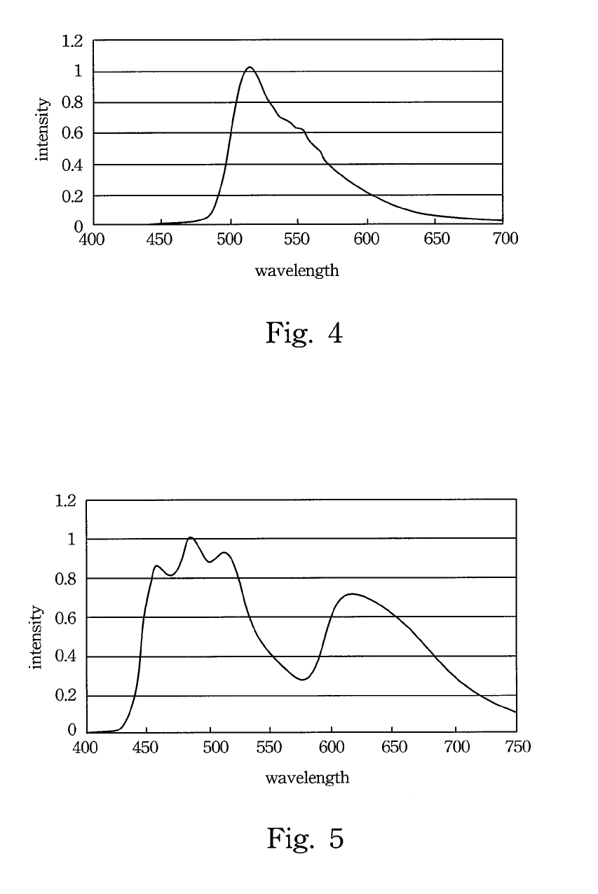

In the present example, the organic light emitting material of the present invention is combined with a green organic light emitting material and a blue organic light emitting material to become a WOLED. The emission spectrum emitted by the organic light emitting material of the present invention is shown in FIG. 1. The emission spectrum emitted by the blue organic light emitting material is shown in FIG. 3. The emission spectrum emitted by the green organic light emitting material is shown in FIG. 4. The WOLED emits white light with the emission spectrum shown in FIG. 5. The intensity peak at the red light component of the white light is located at about a wavelength of 625 nm, which is higher than prior art. When the white light emitted by the WOLED passes through the color filter, the remaining color light components and a white light combination thereof are represented by CIE coordinates as the following table 2 lists.

TABLE 2
The remaining color light components and a white light
combination thereof are represented by CIE coordinates when the white
light emitted by the WOLED passes through the color filter.

| | CIEx | CIEy |
|---|---|---|
| White | 0.312 | 0.339 |
| Red | 0.644 | 0.318 |
| Green | 0.267 | 0.604 |
| Blue | 0.113 | 0.226 |

With reference to table 2, when the white light emitted by the WOLED of the present example passes through the color filter, the remaining green light component is a more saturated green than the typical WOLED.

Therefore, the organic light-emitting diode and the organic light emitting material disclosed by the present invention can increase the display efficiency and the saturation of OLED displays effectively.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An organic light emitting material, characterized in:
an emission spectrum, emitted by the organic light emitting material, having a light intensity ratio of a first wavelength range to an absolute peak of the emission spectrum, wherein the light intensity ratio is equal to or less than 0.2:1, and the first wavelength range is equal to or less than 588 nm.

2. The organic light emitting material of claim 1, wherein the emission spectrum has a wavelength light emitting range from about 560 nm to about 750 nm.

3. The organic light emitting material of claim 1, wherein the absolute peak of the emission spectrum is located within a second wavelength range from about 620 nm to about 750 nm.

4. An organic light emitting material, characterized in:
an emission spectrum, emitted by the organic light emitting material, having an absolute peak located within a first wavelength range from about 620 nm to about 750 nm.

5. The organic light emitting material of claim 4, wherein the emission spectrum has a light intensity ratio of a second wavelength range to the absolute peak of the emission spectrum, the light intensity ratio is equal to or less than 0.2:1, and the second wavelength range is equal to or less than 588 nm.

6. An emission layer of an organic light-emitting diode, comprising:
a host; and
a dopant doped in the host, wherein the dopant has the structure of formulas I, II, III, IV, V or VI,

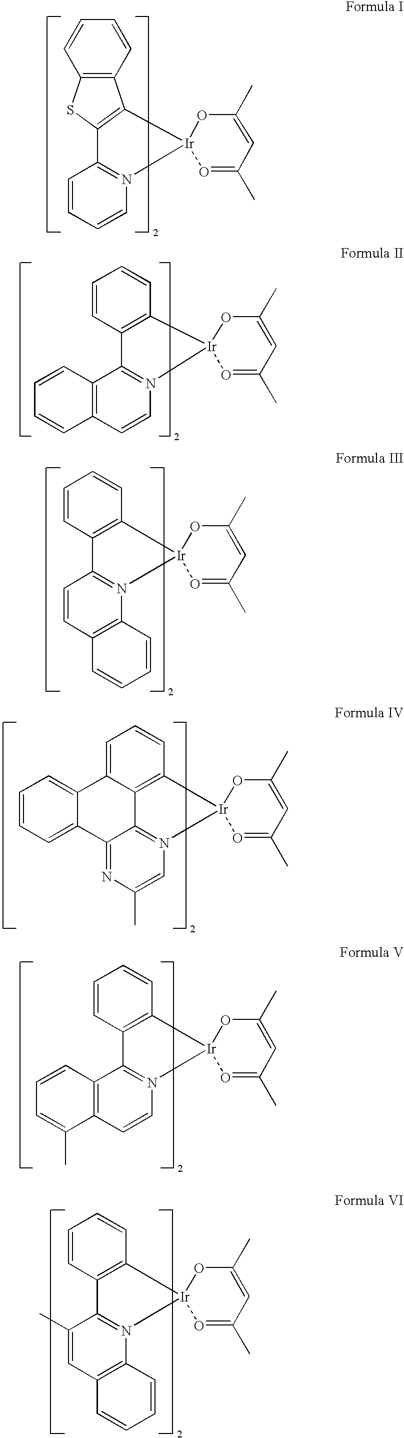

7. The emission layer of claim 6, wherein the host is doped with about 6 wt % to about 15 wt % of the dopant.

8. The emission layer of claim 6, characterized in an emission spectrum, emitted thereby, having a light intensity ratio of a first wavelength range to an absolute peak of the emission spectrum, wherein the light intensity ratio is equal to or less than 0.2:1, and the first wavelength range is equal to or less than 588 nm.

9. The emission layer of claim 8, wherein the emission spectrum has a wavelength emitting range from about 560 nm to about 750 nm.

10. The emission layer of claim 8, wherein the absolute peak of the emission spectrum is located within a second wavelength range from about 620 nm to about 750 nm.
